(19) United States
(12) Patent Application Publication
(10) Pub. No.: US 2015/0348044 A1
(43) Pub. Date: Dec. 3, 2015

(54) SECURE CREDIT CARD TRANSACTIONS BASED ON A MOBILE DEVICE

(71) Applicant: Verizon Patent and Licensing Inc., Arlington, VA (US)

(72) Inventor: Donald E. Smith, Waltham, MA (US)

(73) Assignee: VERIZON PATENT AND LICENSING INC., Arlington, VA (US)

(21) Appl. No.: 14/292,259

(22) Filed: May 30, 2014

(51) Int. Cl. G06Q 20/40; G06Q 20/34; G06Q 20/32

(52) U.S. Cl. CPC G06Q 20/4018; G06Q 20/3226; G06Q 20/3567; G06Q 20/40145; G06Q 20/4012

(57) ABSTRACT

A mobile device may facilitate secure credit card transactions. The mobile device may initialize a mobile credit card verification (MCCV) generator using parameters that are shared with a credit card verifier, and then initialize a rollover timer, where the rollover timer may be synchronized with the credit card verifier. The mobile device may generate an MCCV value based on the parameters, and provide the generated MCCV value to verify a credit card transaction. The mobile device may determine if the rollover timer has reached a predetermined time value, and generating a new MCCV value, based on updated parameters, in response to determining the rollover timer has reached the predetermined time value.

### BACKGROUND

Fraudulent transactions involving credit card accounts are responsible for significant losses in terms of both time and money. In ordinary circumstances, the banks issuing credit card accounts usually absorb the financial losses due to fraud as a “cost of doing business.” While consumers typically do not have to directly bear the financial burden for fraudulent transactions occurring on their accounts, addressing fraudulent activities can be infuriating for the customer, and require time and effort to rectify. Moreover, at some point, banks may pass on the aggregate financial losses due to fraud onto customers in the form of higher interest rates and/or increased service fees. Conventional approaches addressing credit card fraud, such as the “chip and PIN” (personal identification number) system, may involve large and expensive hardware upgrades to merchant equipment. Chip and PIN systems may further involve upgrades to the cards themselves, and could require issuing new cards to millions of existing customers.

### BRIEF DESCRIPTION OF THE DRAWINGS

FIG. 1 is a diagram illustrating an exemplary environment consistent with an embodiments for authenticating transactions using a mobile device;

FIG. 2 is a diagram illustrating exemplary functionality consistent with embodiments that verify transactions using mobile credit card verification (MCCV) values;

FIG. 3 is a diagram showing an exemplary display of a mobile device that provides MCCV values;

FIG. 4 is a block diagram of exemplary components of a credit card verifier according to an embodiment;

FIG. 5 is a block diagram of exemplary components of a mobile device according to an embodiment;

FIG. 6 is a signal flow diagram showing exemplary messages passed between devices when verifying transactions based on MCCV values;

FIG. 7 is a signal flow diagram showing exemplary messages passed between devices when verifying transactions based on transaction verification codes;

FIG. 8 is flow diagram illustrating an exemplary process for verifying transactions based on MCCV values; and

FIG. 9 is flow diagram illustrating an exemplary process for verifying transactions based on transaction verification codes.

### DETAILED DESCRIPTION OF PREFERRED EMBODIMENTS

The following detailed description refers to the accompanying drawings. The same reference numbers in different drawings may identify the same or similar elements.

Embodiments are described herein for securing credit card transactions, where some embodiments may be realized with little or no hardware upgrades to existing transaction hardware (e.g., credit card terminals). For example, a secure credit card transaction system may be implemented in a software application (hereinafter “application” or “app”) installed on mobile devices and/or software upgrades to transaction equipment. In one embodiment, secure credit card transactions may be facilitated by a mobile device using, for example, a standalone application which assists in Mobile Credit Card Verification (MCCV). In one example, a credit card processor (e.g., VISA, MasterCard, etc.) may provide an application, or alternatively, user and account information in a predefined format for use in a common application that may support multiple cards and issuers, which may execute on a mobile device. The application may provide a mobile credit card verification value (hereinafter an MCCV value) which changes dynamically and in coordination with a credit card verifier, which independently generates its own MCCV value. The two independently generated MCCV values may be compared, and if they match, the transaction is approved. Accordingly, the MCCV may provide greater security than a static CCV value printed on the credit card which is conventionally used to verify transactions.

In another embodiment, a transaction identification (ID) value may be generated during the transaction when the customer is purchasing an item. The transaction ID may be provided to the mobile device to generate a first transaction verification code. A second transaction verification code may be independently generated by a credit card verifier using the same transaction ID value. The credit card verifier may then compare the first and second transaction verification codes, and, upon determining a match, approves the proposed transaction.

As used herein, credit card transactions may involve financial transactions associated with credit card accounts, but are not limited to traditional personal and/or business credit accounts which are widely used for credit. Embodiments described herein may be applicable to any transaction that may utilize an account identification card which is realized in a “traditional credit card format” to perform transactions. Such transaction may include exchanges associated with bank accounts, and include, for example, debit cards, automatic teller machine (ATM) cards, rewards cards, gift cards, etc. A card which is realized in a traditional credit card format may be a wallet sized card, typically made of plastic. Such a card may include a magnetic strip having account and user identification encoded therein, and may further include holograms for authenticity, and/or integrated circuits and other electronics for performing data exchanges using, for example, near field communications (NFC).

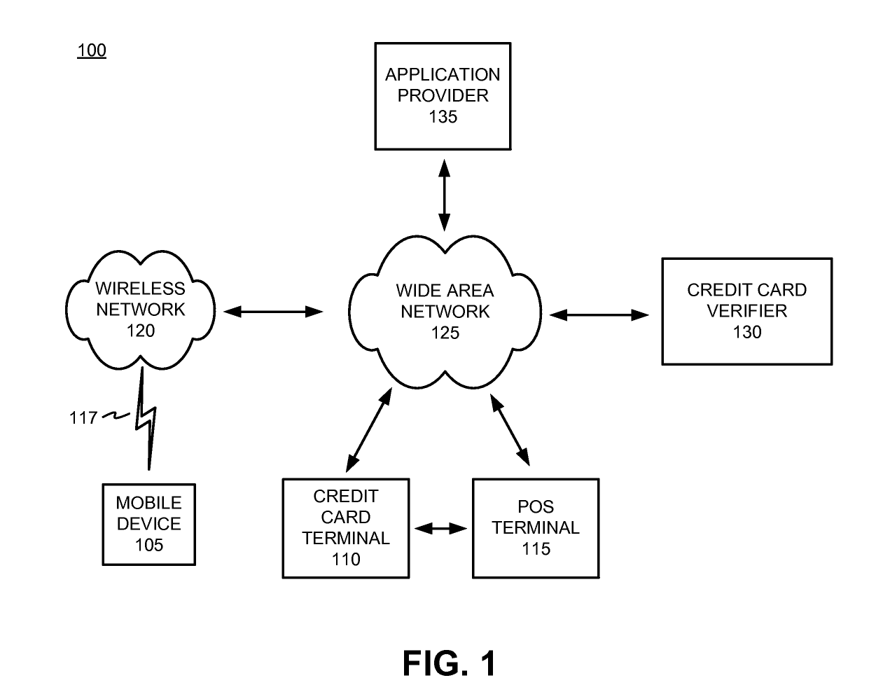

FIG. 1 is a diagram illustrating an exemplary environment 100 consistent with embodiments for authenticating transactions using a mobile device. Environment 100 may include a mobile device 105, a credit card terminal 110, a point of sale (POS) terminal, a credit card verifier 130, and an application provider 135. The devices may be interconnected by wireless network 120 and wide area network 125, as will be explained in more detail below. For ease of explanation, only one mobile device 105, credit card terminal 110, POS terminal 115, credit card verifier 130, and application provider 135 are illustrated in FIG. 1. However, it should be understood that environment 100 may include a plurality of mobile devices 105, credit card terminals 110, POS terminals 115, credit card verifiers 130, application providers and/or other known network entities which may be interconnected by wireless network 120 and/or wide area network 125.

Mobile device 105 may obtain access to wide area network 125 and communicate with other network devices through wireless network 120. Mobile device 105 may communicate with wireless network 120 over any type of known wireless channel 117. For example, access over cellular wireless channel 117 may be provided through a base station (not shown) within wireless network 120. In other embodiments, mobile device 105 may communicate with wide area network 125 using other types of wireless networks, such as wireless local area networks, which may include WiFi (e.g., any IEEE 802.11x network, where x=a, b, c, g, and/or n), or wireless network covering larger areas, which may include mesh networking (e.g., IEEE 802.11s) and/or or a WiMAX IEEE 802.16. Wireless network 120 may exchange data with wide area network 125, where the wide area network may include backhaul networks, backbone networks, metro-area networks, and/or the Internet. Credit card terminal 110, POS terminal 115, credit card verifier 130, and application provider 135 may interface with each other over wide area network 125, and with mobile device 105 through wireless network 120. Additionally, credit card terminal 110 and POS terminal 115 may share a dedicated local interface for quickly and securely exchanging data when performing transactions.

Mobile device 105 may further include additional interfaces for communicating with credit card terminal 110 and/or POS terminal 115 (not shown in FIG. 1). For example, mobile device 105 may exchange data directly with the credit card terminal 110 and/or POS terminal 115 using wireless near field communications (NFC), WiFi, low energy Bluetooth, etc. In another embodiment, mobile device 105 may provide data to the POS terminal 115 using optical transfer, such as, for example, quick response (QR) codes or bar codes, by displaying coded data on a display of mobile device 105. In such an embodiment, a scanner (either a hand held scanner or a flat scanner) that is typically used by POS terminal 115 to scan codes on merchandise tags could be used to read data in the form of QR codes and/or bar codes displayed by mobile device 105. Moreover, data collected by the POS terminal 115 using the scanner may be provided to credit card terminal 110 as needed, either through a dedicated interface, and/or over wide area network 125.

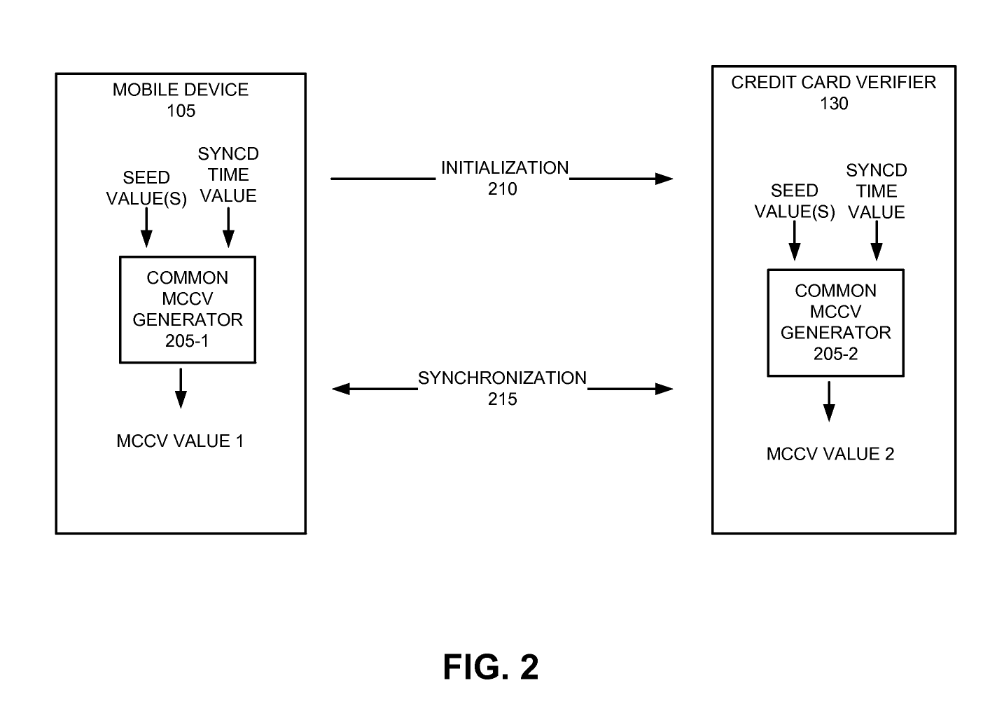

Further referring to FIG. 1, in an embodiment, an application (hereinafter referred to as an “MCCV application” or an “MCCV app”) running on mobile device 105 may facilitate secure transactions by generating MCCV values which change over time (e.g., the MCCV values roll-over after a predetermined period of time). MCCV applications may be developed by credit card issuers (such as, for example, banks or credit unions) and/or by account processors (e.g., credit card processors such as VISA and MasterCard). Alternatively, a common or shared MCCV application may be used (e.g., such as a “wallet” application) to facilitate secure transactions for multiple cards and/or accounts from different processors and/or issuers. The MCCV application may be distributed by application provider 135 (such as, for example, Google Play, iOS App Store, etc.), and downloaded to mobile device 105. Once installed, the application may be initialized with the account information, PIN, and/or password of the user, which may then be subsequently be sent to credit card verifier 130 over wide area network 125. After initialization, the MCCV application does not have to rely on the wireless connectivity, nor infrastructure support of the wireless carrier (e.g., transaction servers, etc.) to verify transactions, because the same MCCV values are generated substantially in parallel by both mobile device 105 and credit card verifier 130. Details of how the MCCV values are generated are described below in relation to FIG. 2. In other embodiments, different classes of machines other than mobile devices may be used to verify transactions, such as, for example, desktop computers. For example, an MCCV application compatible with the operating system of the desktop computer may be downloaded from application provider 135, and be used for verifying credit card transactions for purchases made over the internet.

When making a purchase at a merchant, MCCV may involve a few behavioral changes on the part of the customer (e.g., the user of the mobile device) in a store. For example, when the user is about to make a credit card purchase at a credit card terminal, the user may first activate, possibly with a PIN or password, the MCCV app on mobile device 105. On the display of mobile device 105, the MCCV app may provide an MCCV value which may be entered after the user swipes the card in credit card terminal 110 (or alternatively, the cashier enters/swipes the credit card in POS terminal 115). Upon the credit card being swiped, the credit card terminal 110 may transmit the credit card number and the CCV1 encoded in the magnetic stripe to credit card verifier 130 over wide area network 125. Credit card verifier 130 may check in its database whether or not the user is enrolled in MCCV. If not, the transaction will proceed using conventional processes. If the user does use MCCV, card authenticator 130 may send a message to credit card terminal 110 and/or point-of-sale terminal 115 to prompt the user to enter the MCCV, which is displayed by the MCCV app on mobile device 105, into a keypad on credit card terminal 110. In alternative embodiments, the MCCV value generated by mobile device 105 may be wirelessly sent to credit card terminal 110 and/or POS terminal 115. Alternatively the MCCV value may be encoded in a QR code and/or bar code, and displayed on mobile device 105. Using an optical reader, POS terminal 115 may scan the display of mobile device 105 to read the displayed code and receive the MCCV value. Credit card terminal 110 may send the MCCV value to credit card verifier 130 over wide area network 125, which may compare the received MCCV to its own dynamically changing MCCV for associated with the user of mobile device 105. If the MCCV values match, credit card verifier 130 will authorize the transaction.

In another embodiment, MCCV may be employed to verify transactions occurring over the Internet which are initiated by the user. Internet transactions using mobile device 105 (or any computer running the MCCV app) may process even faster than in a retail location. For example, once a user enters a credit card number (or selects one from a list) into the retailer's web site, instead of prompting the user to enter a CCV manually, the computer could, with the user's permission, invoke the MCCV app, which may populate the CVV field automatically with the MCCV value. The invocation of the MCCV app on the computer may be triggered by the website (with the user's permission), automatically by the computer recognizing a transaction is being performed (for example, by using a whitelisted URL corresponding to a recognized e-merchant), or manually by the user.

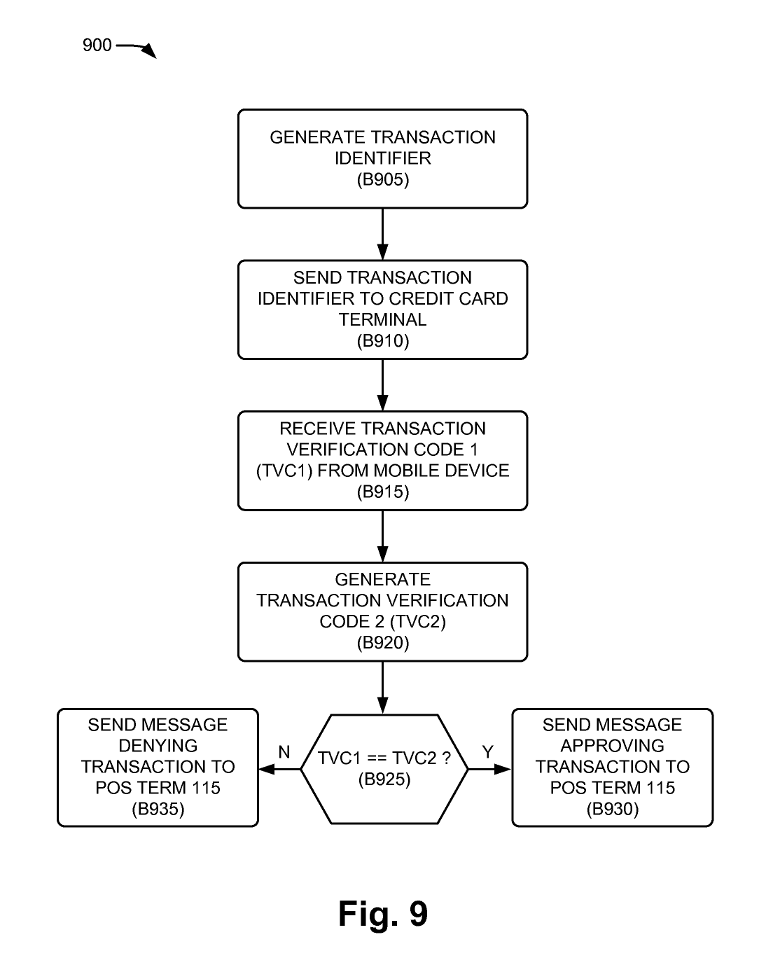

In various embodiments described above, both the mobile device 105 and credit card verifier 130 may independently generate separate rolling MCCV values in a synchronous manner, as will be described in below in more detail relation to FIG. 2. Given the MCCV value may be entered by the user, for example, through a keypad on credit card terminal 110, mobile device 105 does not require connectivity to a network when validating transactions, since the MCCV application residing on mobile device 105 independently generates MCCV values. In another embodiment, mobile device 105 may instead generate a transaction verification code (TVC) based upon a transaction identifier (ID) it may receive over wide area network 125 via wireless network 120. In one embodiment, the transaction ID may be generated by credit card verifier 130 based upon receiving a request from POS term 115. The transaction ID may be sent to the credit card terminal 110, where it subsequently may be wirelessly provided to mobile device 105. Mobile device 105 may then generate a first TVC based in part on the received transaction ID. The first TVC may be sent to credit card verifier 130 by mobile device 105 over wide area network 125 via wireless network 120. Credit card verifier 130 may then generate a second TVC based on the same transaction ID used by mobile device 105 to generate the first TVC. Once the second TVC is generated, credit card verifier 130 may compare the first TVC with the second TVC. If the first TVC and the second TVC match, the credit card verifier may send a transaction verification message to POS term 115. As will be described in relation to FIG. 9, different embodiments provide for variations as to which entity may generate the transaction ID (e.g., credit card terminal 110 or POS terminal 115).

Mobile device 105 may include any type of electronic device having communication capabilities, and thus communicate over network 115 using a variety of different channels, including both wired and wireless connections. Mobile device 105 may include, for example, a cellular radiotelephone, a smart phone, a tablet, a mobile phone, any type of IP communications device, a Voice over Internet Protocol (VoIP) device, a laptop computer, a palmtop computer, a gaming device, or a media player device. In other embodiments, a desktop computer (not pictured) may be used in place of mobile device 105, where the desktop computer may have wired or wired access to wide area network 125, and a software application for facilitating MCCV which is compatible with the operating system of the desktop computer.

Credit card terminal 110 may be a conventional device which permits a user to swipe a credit card to read the account information encoded on the magnetic stripe of the credit card, enter an MCCV value through a keypad, and/or accept a user's signature for accepting the transaction. Credit card terminal 110 may be a microprocessor driven device running embedded programming and a real-time operating system from memory, and include a keypad and/or touchscreen for receiving user input. Credit card terminal 110 may further include a display for providing prompts and information to the user for completing the transaction. Credit card terminal 110 may share a dedicated interface with POS terminal 115, to exchange information for completing the transaction. For example, in one embodiment where credit card terminal 110 does not have a keypad, and may receive MCCV values from POS terminal 115 over the dedicated interface. In some embodiments, credit card terminal may also include wireless transceivers (e.g., NFC, low energy Bluetooth, etc.) for communicating with mobile device 105 (e.g., for receiving MCCV values generated by the mobile device).

POS terminal 115 may be a device which may be used complete transactions occurring in “brick-and-mortar” establishments, which are typically retail stores. POS terminals may be custom hardware devices, or may be general purposed desktop/laptop computers, smartphones, and/or tablets, configured by software to perform point of sale operations. POS terminal 115 may include optical scanners for reading QR codes and/or bar codes, which may be used for receiving MCCV values.

Credit card verifier 130 may be any type of network entity, server, etc. suitably configured to authorize transactions based on information received over wide area network 125. Credit card verifier 130 may communicate with credit card terminal 110 and/or POS terminal 115 over wide area network 125 when verifying transactions. In some embodiments, credit card verifier may also communicate with mobile device 105 over wide area network 125 via wireless network 120 when verifying transactions using transaction verification codes (TVCs).

Application provider 135 may be a server that acts as a repository for applications that may be downloaded and executed by mobile device 105. Application provider 135 may communicate with mobile device via wide area network 125 through wireless network 120. While only one application provider 135 is shown in FIG. 1, in various embodiments, multiple application providers may be associated with different entities and used within environment 100.

Wireless network 120 may include one or more wireless networks of any type, such as, for example, a local area network (LAN), a wide area network (WAN), a wireless satellite network, and/or one or more wireless public land mobile networks (PLMNs). The PLMN(s) may include a Code Division Multiple Access (CDMA) 2000 PLMN, a Global System for Mobile Communications (GSM) PLMN, a Long Term Evolution (LTE) PLMN and/or other types of PLMNs not specifically described herein.

Wide area network 125 may be any type of wide area network that connects back-haul networks and/or core networks, and may include a metropolitan area network (MAN), an intranet, the Internet, a cable-based network (e.g., an optical cable network), networks operating known protocols, including Asynchronous Transfer Mode (ATM), Optical Transport Network (OTN), Synchronous Optical Networking (SONET), Synchronous Digital Hierarchy (SDH), Multiprotocol Label Switching (MPLS), and/or Transmission Control Protocol/Internet Protocol (TCP/IP).

FIG. 2 is a diagram illustrating exemplary functionality consistent with embodiments that verify transactions using mobile credit card verification (MCCV) values. FIG. 2 illustrates exemplary functional blocks within mobile device 105 and credit card verifier 130 that may be used for performing MCCV. A common MCCV generator (herein referred to plurally as “common MCCV generators 205” and individually as “common MCCV generator 205-x,” where “x”=1, 2, . . . , N) may be used for generating MCCV values used in verification. Common MCCV generators 205 may use algorithms (e.g., cryptographic rolling code generators, such as those used in two-factor authentication) that receive inputs that may include one or more seed values and a synchronized time value. The synchronized time value may be generated by reasonably accurate internal clocks residing in mobile device 105 and credit card verifier 130. The internal clocks may be free running on mobile device 105 and credit card verifier 130, and in order to synchronize the generation of MCCV values, the internal clocks should be synchronized by a common time reference to compensate for clock drift. In some embodiments, the common time reference may be provided over wireless network 120 and/or wide area network 125.

In an embodiment, after mobile device 105 initially downloads the MCCV app which includes common MCCV generator 205-1, the MCCV app may perform an initialization process. During the initialization process, one or more seed values, which may be unique to the user of mobile device 105 (e.g., name, account number, and/or pin value), may be input by the user, and subsequently provided to credit card verifier 130 in an initialization message 210. During initialization, the internal clocks in mobile device 105 and credit card verifier may be synchronized using a common time reference. Once the seed value(s) have been shared with credit card verifier 130, and the internal clocks in mobile device 105 and credit card verifier 130 have been synchronized, common MCCV generator 205-1 and common MCCV generator 205-2 will independently produce matching MCCV values (MCCV value 1 and MCCV value 2, respectively) which may be used for authenticating credit card transactions. To increase security, the MCCV values may be rolling values, that is, the values expire after a predetermined period, and new MCCV values are generated to perform subsequent verifications. To compensate for clock drift over time, synchronization message(s) 215 may be periodically provided to resynchronize the internal clocks of mobile device 105 and credit card verifier 130.

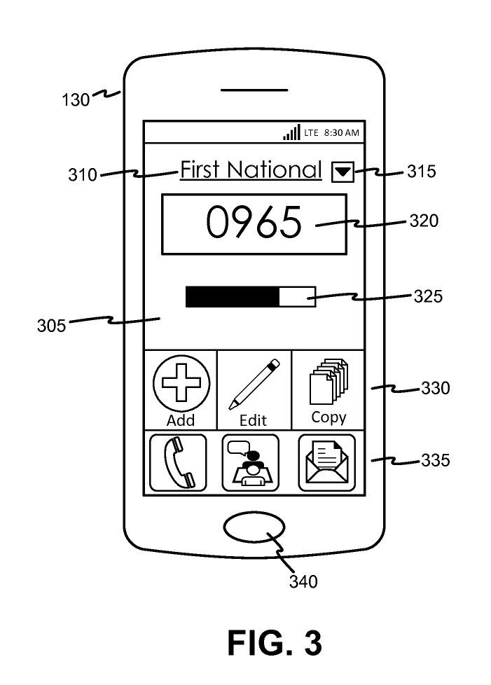

FIG. 3 is a diagram showing an exemplary touch screen display 305 of mobile device 130 when the MCCV application is running in the foreground. Display 305 may be created by the MCCV app as downloaded from application provider 135. FIG. 3 illustrates an embodiment which shows a single application that may perform MCCV for a number of different accounts and/or card providers, thus acting as a “wallet” application for the convenience of the user. By using common APIs and predefined data formats, different providers may interface with the common application to facilitate MCCV. On display 305, MCCV application may show the name 310 of the account (e.g., “First National” as depicted in FIG. 3). A pull-down control 315 may be used to select other accounts for which MCCV app can verify transactions. While embodiments here refer to verifying transactions associated with credit card accounts, MCCV app may also be used to facilitate verification of exchanges, purchases, and various other transactions of value associated with other accounts. For example, MCCV app may also be used to verify transactions associated with, for example, bank accounts, debit cards, automatic teller machine (ATM) cards, rewards cards, gift cards, etc.

Once the user selects the desired account with pull down menu 315, the name 310 of the selected account may be displayed. The MCCV app may then generate and display an MCCV value 320 which may be, for example, entered by the user into credit card terminal 110 using a keypad. The MCCV value 320 is only valid for a predetermined period of time, and a new value may be generated and displayed upon expiration of the time period. To provide the user with some information as to when the MCCV value 320 will change, or “rollover,” a graphic indicator 325 may be displayed indicating how long the current MCCV value 320 may be used. If too much time elapses between entering the MCCV value and submitting the order, the MCCV value 320 may expire, and the user will have to reenter a new valid MCCV number so the credit card verifier 130 may verify the transaction. Accordingly, display 325 is provided to prevent expiration of the current MCCV value 320 prior to completing a transaction. However, other options may be available to prevent or deal with expiration. For example, credit card terminal 110 (or, if the transaction is occurring over the internet, the web site of the retailer) can provide the MCVV value immediately before processing the order to make expiration less likely. If the MCVV value has expired or is entered incorrectly, the credit card verifier 130 can ask the user to resubmit the MCVV. Alternatively, the predetermined period of time may be set so that the MCVV “lifetime” is short enough to maintain an adequate level of security, but long enough to prevent frequent expirations.

Display 305 may include a command area 330 where, as shown from left to right in FIG. 3, the user can enter commands to add new accounts, edit parameters associated with existing accounts (e.g., change passwords), or copy MCCV values for pasting into other fields when shopping over the web. Display 305 may also include communication area 335, where the user may contact the selected account provider if a problem occurs with the account. For example, as shown from left to right in area 335, the user may be given the options of calling the provider, sending the provider a text message, or sending the provider an email.

Access to the MCCV app may restricted for security by requiring a PIN, password, and/or other credentials which are known to, or exclusively associated with, the user of mobile device 130. For example, the MCCV app may require input from a fingerprint reader 340 to verify that it is the user seeking to access and run the MCCV application to verify a transaction. In some embodiments, the PIN, password, and/or other credentials (e.g., fingerprint data of the user) may be included as seed values to generate the MCCV values by common MCCV generators 205 shown in FIG. 2. While the user input may be provided via a touch screen 305 as described above, other embodiments may use various sensors commonly found on mobile devices to enter commands. Accordingly, commands may be alternatively or additionally received through, for example, a camera, accelerometer, microphone, and/or position sensor (e.g., for geo-fencing restrictions) which may be found in mobile device 130.

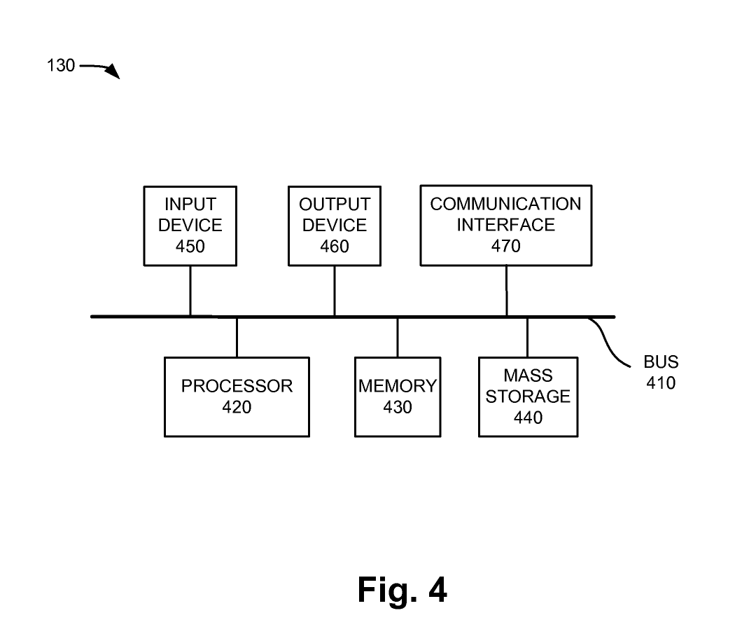

FIG. 4 is a block diagram of exemplary components of a credit card verifier (CCV) 130 which may perform transaction verification. Credit card verifier 130 may include a bus 410, a processor 420, a memory 430, mass storage 440, an input device 450, an output device 460, and a communication interface 470. Bus 410 includes a path that permits communication among the components of CCV 130. Processor 420 may include any type of single-core processor, multi-core processor, microprocessor, latch-based processor, and/or processing logic (or families of processors, microprocessors, and/or processing logics) that interprets and executes instructions. In other embodiments, processor 420 may include an application-specific integrated circuit (ASIC), a field-programmable gate array (FPGA), and/or another type of integrated circuit or processing logic. For example, the processor 420 may be an x86 based CPU, and may use any operating system, which may include varieties of the Windows, UNIX, and/or Linux. The processor 420 may also use high-level analysis software packages and/or custom software written in any programming and/or scripting languages for interacting with other network entities and providing verification of credit card transactions over wide area network 125.

Memory 430 may include any type of dynamic storage device that may store information and/or instructions, for execution by processor 420, and/or any type of non-volatile storage device that may store information for use by processor 420. For example, memory 430 may include a RAM or another type of dynamic storage device, a ROM device or another type of static storage device, and/or a removable form of memory, such as a flash memory. Mass storage device 440 may include any type of on-board device suitable for storing large amounts of data, and may include one or more hard drives, solid state drives, and/or various types of RAID arrays. Mass storage device 440 would be suitable for storing files associated verifying credit card transactions.

Input device 450, which may be optional, can allow an operator to input information into CCV 130 if required. Input device 450 may include, for example, a keyboard, a mouse, a pen, a microphone, a remote control, an audio capture device, an image and/or video capture device, a touch-screen display, and/or another type of input device. In some embodiments, CCV 130 may be managed remotely and may not include input device 450. Output device 460 may output information to an operator of CCV 130. Output device 460 may include a display (such as an LCD), a printer, a speaker, and/or another type of output device. In some embodiments, CCV 130 may be managed remotely and may not include output device 460.

Communication interface 470 may include a transceiver that enables CCV 130 to communicate over wide area network 125 with other devices and/or systems. The communications interface 470 may be a wireless communications (e.g., RF, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 470 may include a transmitter that converts baseband signals to RF signals and/or a receiver that converts RF signals to baseband signals. Communication interface 470 may be coupled to one or more antennas for transmitting and receiving RF signals. Communication interface 470 may include a logical component that includes input and/or output ports, input and/or output systems, and/or other input and output components that facilitate the transmission/reception of data to/from other devices. For example, communication interface 470 may include a network interface card (e.g., Ethernet card) for wired communications and/or a wireless network interface (e.g., a WiFi) card for wireless communications.

As described below, CCV 130 may perform certain operations relating to the verification of credit card transactions over wide area network 125. CCV 130 may perform these operations in response to processor 420 executing software instructions contained in a computer-readable medium, such as memory 430 and/or mass storage 440. The software instructions may be read into memory 430 from another computer-readable medium or from another device. The software instructions contained in memory 430 may cause processor 420 to perform processes described herein. Alternatively, hardwired circuitry may be used in place of, or in combination with, software instructions to implement processes described herein. Thus, implementations described herein are not limited to any specific combination of hardware circuitry and software.

Although FIG. 4 shows exemplary components of CCV 130, in other implementations, CCV 130 may include fewer components, different components, additional components, or differently arranged components than depicted in FIG. 4.

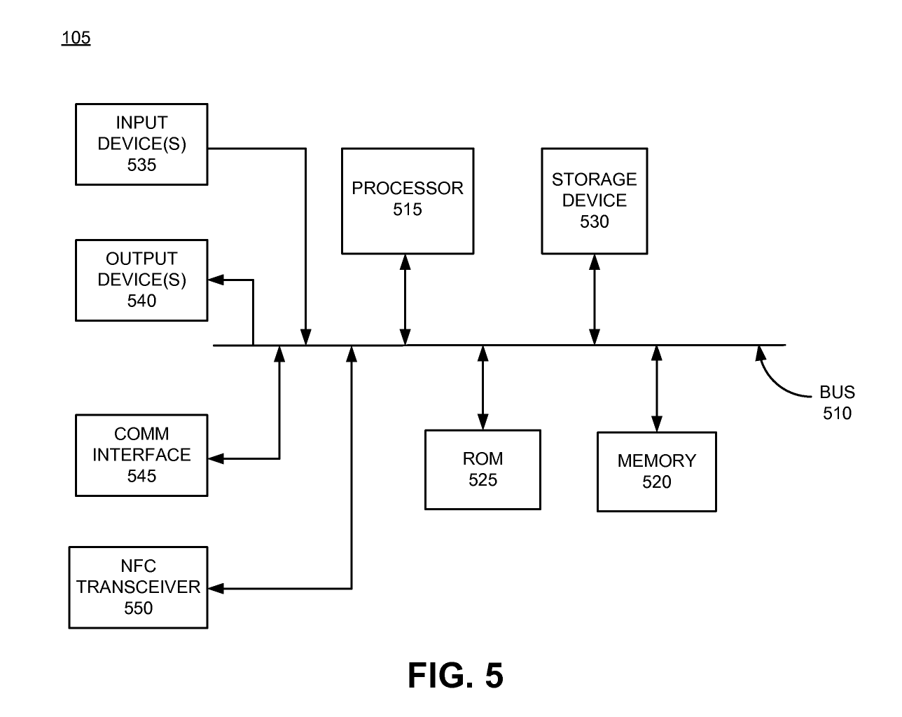

FIG. 5 is a block diagram of exemplary components of a mobile device 105 according to an embodiment. Mobile device 105 may include a bus 510, a processor 515, memory 520, a read only memory (ROM) 525, a storage device 530, an input device(s) 535, an output device(s) 540, a communication interface 545, and a Near Field Communications (NFC) transceiver 550. Bus 510 may include a path that permits communication among the elements of mobile device 105.

Processor 515 may include a processor, microprocessor, or processing logic that may interpret and execute instructions. Memory 520 may include a random access memory (RAM) or another type of dynamic storage device that may store information and instructions for execution by processor 515. ROM 525 may include a ROM device or another type of static storage device that may store static information and instructions for use by processor 515. Storage device 530 may include a magnetic and/or optical recording medium and a corresponding drive.

Input device(s) 535 may include one or more mechanisms that permit an operator to input information to mobile device 105, such as, for example, a touchscreen, a keypad or a keyboard, a microphone, voice recognition and/or biometric mechanisms such as fingerprint readers, cameras, etc. Output device(s) 540 may include one or more mechanisms that output information to the operator, including a display, a speaker, etc. Communication interface 545 may include any transceiver mechanism that enables mobile device 105 to communicate with other devices and/or systems. For example, communication interface 545 may include mechanisms for communicating with another device or system via a network, such as wireless networks 20. A Near Field Communications (NFC) transceiver 550 may interface with bus 510 to permit mobile device 105 to exchange data with NFC readers, thus allowing convenient transactions with appropriately equipped credit card terminal(s) 110, POS terminal(s) 120, kiosks, building security gateways, etc.

Mobile device 105 may perform certain operations or processes, as may be described in detail below. Mobile device 105 may perform these operations in response to processor 515 executing software instructions contained in a computer-readable medium, such as memory 520. A computer-readable medium may be defined as a physical or logical memory device. A logical memory device may include memory space within a single physical memory device or spread across multiple physical memory devices.

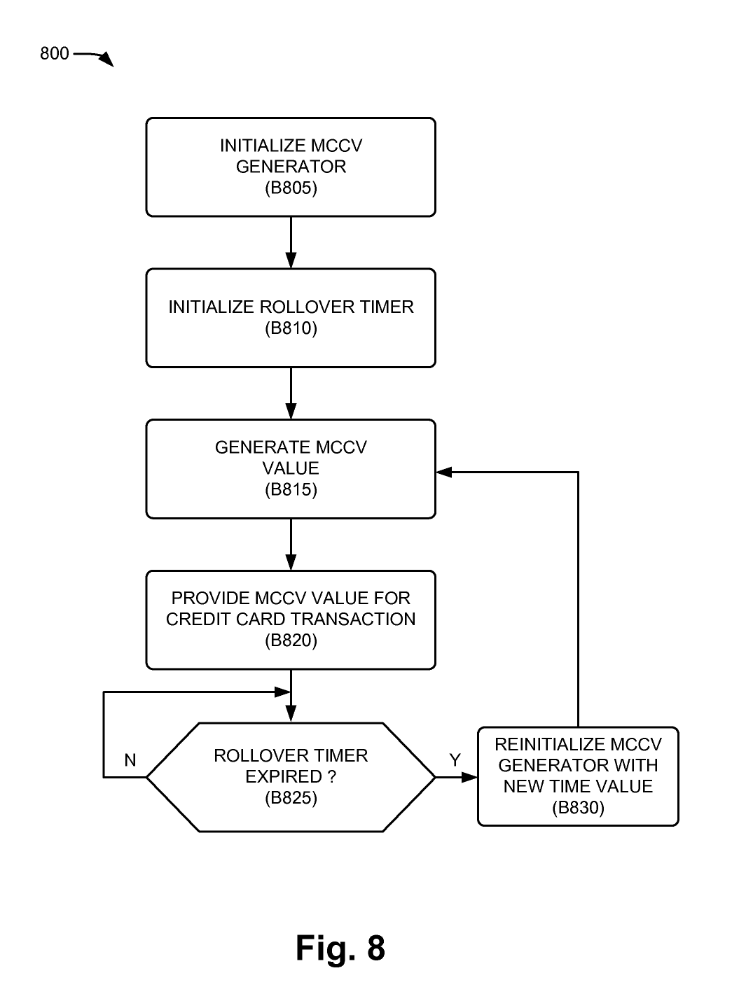

Software instructions may be read into memory 520 from another computer-readable medium, such as storage device 530, or from another device via communication interface 545, which may obtain instructions from application provider 135. The software instructions contained in memory 520 may cause processor 515 to perform operations or processes that will be described in detail with respect to FIG. 8 or FIG. 9. Alternatively, hardwired circuitry may be used in place of or in combination with software instructions to implement processes consistent with the principles of the embodiments. Thus, exemplary implementations are not limited to any specific combination of hardware circuitry and software.

The configuration of components of mobile device 105 illustrated in FIG. 5 is for illustrative purposes only. It should be understood that other configurations may be implemented. Therefore, mobile device 105 may include additional, fewer and/or different components than those depicted in FIG. 5.

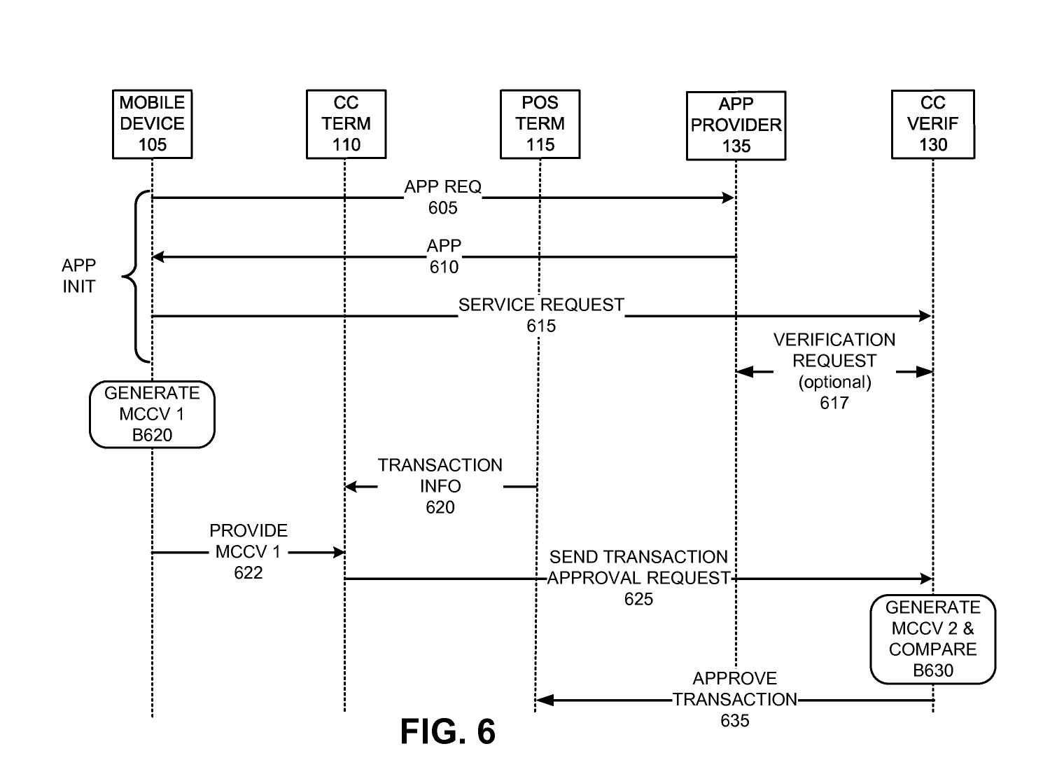

FIG. 6 is a signal flow diagram showing exemplary messages passed between devices when verifying transactions based on MCCV values. Initially, if mobile device 105 does not have the MCCV application stored in non-volatile program memory, the user may obtain the MCCV application from application provider 135. This may be facilitated through a number of exchanges labeled “APP INIT” in FIG. 6. During APP INIT, the mobile device 105 may initially send an app request (605) to application provider 135. In response, application provider 135 may provide the MCCV application (610) to the mobile phone over wireless network 120 via wide area network 125. Once downloaded, mobile device 105 may initialize the application by prompting the user for various information, including the user's account information and/or security credential(s) (e.g., password, pin, fingerprint scan, etc.). The information provided by the user to mobile device 105, or portions thereof, may be included in a service request (615), which is sent to credit card verifier 130. Information included in service request 615 may be used to set up the users' account so MCCV may be performed. Additionally, information included in service request 615 may also be used by credit card verifier 130 as seed value(s) which are input into the common MCCV generator 205-2 to generate MCCV values. In some embodiments, prior to the setting up the user's account for using MCCV, credit card verifier 130 may verify the credentials of the mobile device 105 that sent the service request 615, for example, by sending a verification request (617) to application provider.

After the MCCV application is installed and initialized, it may be invoked by the user in a manner consistent with the operating system of mobile device 105. The MCCV application may request the user to enter, for example, a PIN, a password, and/or some other credential(s) unique or known only to the user (such as, for example, a fingerprint scan). The MCCV app may generate MCCV values (MCCV 1) in a free running and ongoing manner based on the seed values(s) and the synchronized time value (B620).

When the user wishes to make a purchase and begins the process of making a transaction, POS terminal 115 may provide the transaction information (e.g., product cost, store identity, user identity, etc.) to credit card terminal 110. Credit card terminal may prompt the user to swipe the credit card, and then enter a MCCV value. The user may invoke the MCCV app by entering, for example, a PIN as described above, and then provide the MCCV value (MCCV1) (622) generated by mobile device 105. The user may manually enter MCCV1, which may be shown on display 305 as depicted in FIG. 3, using a keypad associated with credit card terminal 110. In alternative embodiments, MCCV1 may be provided to credit card terminal 110 using wireless transmissions or optical scanning. Upon receiving MCCV1, credit card terminal 110 may send a request to approve the transaction (625) to credit card verifier 130. Credit card verifier 130 may independently generate an MCCV value (MCCV2) using the seed value(s) associated with the user and account (which were provided in service request (615) during the APP INIT process) and the synchronized time value. Note that algorithm used in CC verifier 130 may account for small time differences introduced by delays due to machine processing or message transit time. This may be done by appropriately quantizing the synchronized time value used to calculate the MCCV values, and/or by introducing appropriate tolerances in the MCCV values. Credit card verifier 130 may compare MMCV1 and MCCV2, and if they are the same (or within a specific tolerance), CC verifier 130 will send a message approving the transaction (635) to POS terminal 115.

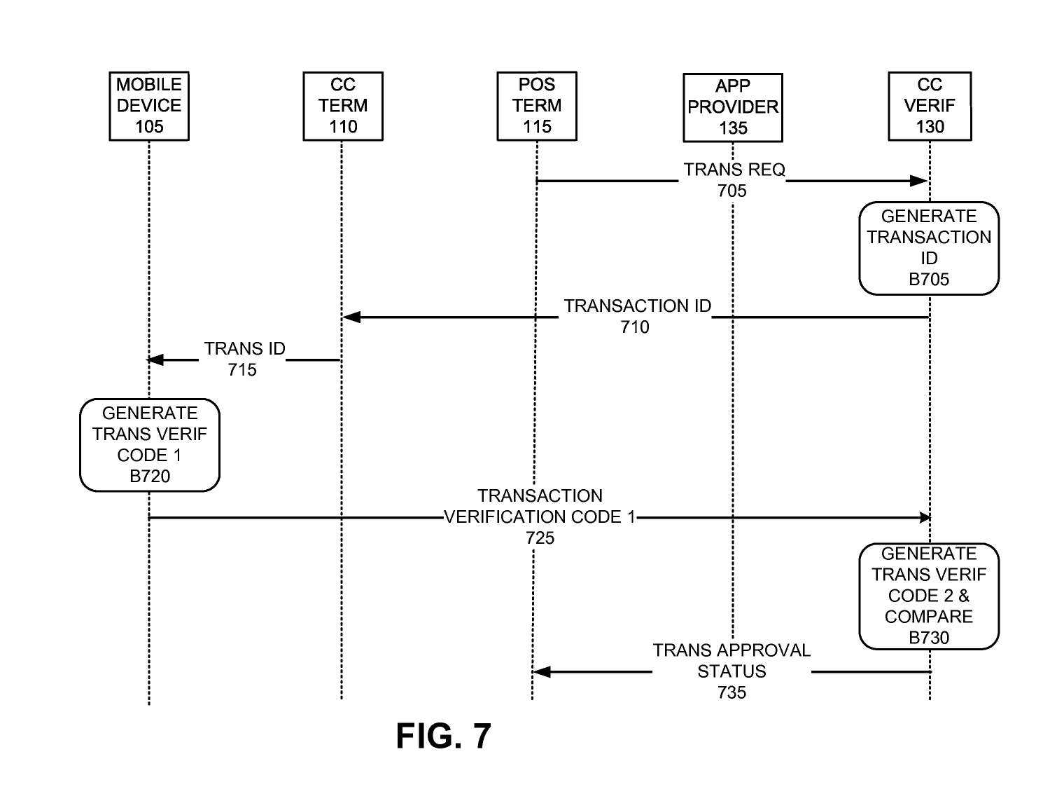

FIG. 7 is a signal flow diagram showing exemplary messages passed between devices when verifying transactions based on transaction verification code (TVC) values. A TVC application may reside on mobile device 105 which may generate TVC values. If the TVC application is not resident in the non-volatile program memory of mobile device 105, the TVC application may be downloaded from application provider 135 in a similar manner as shown in the group of messages labeled APP INIT which shown in FIG. 6, but not duplicated in FIG. 7 for the sake of brevity.

When the user wishes to make a purchase and begins the process of making a transaction, POS terminal 115 may send a transaction request (705) to credit card verifier 130. The credit card verifier 130 may generate a transaction ID (B705) to establish a unique and secure identifier for the transaction which may be used in subsequent steps to verify the transaction. In an embodiment, CC Verifier 130 may send the transaction ID (710) to credit card terminal 110. Credit card terminal 110 may forward the transaction ID (715) to mobile device 105. This may be done using wireless channel between mobile device 105 and CC terminal 110, which may include WiFi, NFC, and/or low power Bluetooth. In other embodiments, the transaction ID may be generated by CC terminal 110, and provided to CC verifier 130 and mobile device 105 (not shown).

Mobile device 105 may generate a first Transaction Verification Code (TVC1) based in part on the received transaction ID (B720). A TVC may be generated using similar algorithms as MCCV values described above, but includes the received transaction ID as a seed value. Mobile device 105 may then send TVC1 (725) to CC verifier 130. Using the same transaction ID which was used by mobile device 105, CC verifier 130 may generate a second TVC (TVC2), and compare TVC1 and TVC2 to determine if there is a match (B730). If TVC1 and TVC2 are the same (or similar to within a predetermined tolerance), CC verifier 130 may send a transaction approval status message (735) to the POS terminal 115, indicating that the transaction is approved.

FIG. 8 is flow diagram illustrating an exemplary process 800 for verifying transactions based on MCCV values. Process 800 may performed by mobile device 105, for example, by executing instructions on processor 515 which may be stored in memory 520. Initially, after the MCCV app is invoked, mobile device 105 may initialize MCCV generator using parameters which are shared with a credit card verifier (Block 805). The parameters may include one or more seed values and a common time value which is synchronized with the CC verifier 130. The MCCV app may be invoked upon entering a personal identification number (PIN), a password, and/or a biometric signature associated with the user. A biometric signature may be obtained, for example, by a fingerprint scanner on mobile device 105. The PIN, password, and/or biometric signature may be included as seed value(s) for the MCCV generator.

Mobile device 105 may initialize a rollover timer which is based on the common time value (Block 810). The rollover timer may expire after a predetermined period of time, which is also shared by the CC verifier 130. Accordingly, the rollover timer in mobile device 105 and a rollover timer in CC verifier 130 are independently running timers which are synchronized based on the common time value. The common time value may be provided by a network (e.g., wireless network 120. Over time, as timers tend to drift, mobile device 130 may synchronize its rollover timer with the rollover timer running in CC verifier 130. The synchronization may be performed on a periodic basis.

Mobile device 105 may generate an MCCV value based on the above parameters (Block 815). The MCCV values may be determined with an algorithm which is shared with the CC verifier 130.

Mobile device 105 may then provide the generated MCCV value to verify a credit card transaction (Block 820). The MCCV value may be shown on the display 305 of on mobile device 105 in a manner which conveys the amount of time remaining until the rollover timer reaches the predetermined time value. The MCCV value may be manually entered into CC terminal 110 and/or POS terminal 115 using a keypad. In alternate embodiments, the MCCV value may be sent to CC terminal 110 and/or POS terminal 115 using a wireless channel and/or using optical techniques which include scanning display 305 while display a QR code and/or bar code which encodes the MCCV value.

Mobile device 105 may determine if the rollover timer has reached a predetermined time value (Block 825). If so, the timer as “rolled over” and mobile device 105 may reinitialized the MCCV generator 205-1 to generate a new MCCV value, and then generate a new MCCV value based on the current timer value (Block 830).

In an embodiment, mobile device 105 may receive a deactivation signal from CC verifier 130 upon notification that the mobile device is lost or stolen. Receiving the deactivation signal may result preventing the mobile device 105 from generating MCCV values to verify credit card transactions. Additionally, after receiving the deactivation signal, mobile device 105 may generate a code which appears to be a valid MCCV value, but instead indicates that the mobile device being used in an unauthorized manner.

FIG. 9 is flow diagram illustrating an exemplary process 900 for verifying transactions based on transaction verification code (TVC) values. Process 900 may performed by CC verifier 130, for example, by executing instructions on processor 420 which may be stored in memory 430 and/or mass storage 440. Initially, CC verifier 130 may generate a transaction identifier (ID) (B905). In other embodiments, the transaction ID may be generated elsewhere, such as, for example, CC terminal 110 and/or POS terminal 115, and subsequently sent to CC verifier 130.

CC verifier 130 may then send the transaction ID to CC terminal (B910). The CC terminal 110 may subsequently forward the transaction ID to mobile device 105. In an alternative embodiment, the transaction ID may be sent directly to the mobile device 105 by the CC verifier 130 (step not shown in FIG. 9) via wireless network 120.

CC verifier 130 may then receive a first transaction verification code (TVC1) from mobile device 105, where TVC1 is based in part on the received transaction identifier (B915). CC verifier 130 may then generate a second transaction verification code (TVC2) which is based on the transaction ID value used by the mobile device to generate TCV1 (B920). CC verifier may then compare TVC1 and TVC2 to determine if they match (B925). If CC verifier 130 determines a match in B925, it may send a message approving the transaction to POS terminal 115 (B930). If CC verifier 130 determines that TVC1 and TVC2 do not match in B925, CC verifier 130 may send a message to POS terminal 115 denying the transaction (B935). In alternative embodiments messages approving or denying the transactions may be sent alliteratively or additionally, to CC terminal 110.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while a series of blocks has been described with respect to FIGS. 8 and 9, and signal flows with respect to FIGS. 6 and 7, the order of the blocks and signal flows may be modified in other implementations. Further, non-dependent blocks and signal flows may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code. It being understood that software and control hardware can be designed to implement these aspects based on the description herein.

Further, certain portions of the invention may be implemented as a “component” or “system” that performs one or more functions. These components/systems may include hardware, such as a processor, an ASIC, a FPGA, or other processing logic, or a combination of hardware and software.

To the extent the aforementioned embodiments collect, store or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method, comprising:
initializing a mobile credit card verification (MCCV) generator using parameters that are shared with a credit card verifier;
initializing a rollover timer, wherein the rollover timer is synchronized with the credit card verifier;
generating, at a mobile device, an MCCV value based on the parameters;
providing the generated MCCV value to verify a credit card transaction;
determining if the rollover timer has reached a predetermined time value; and
generating a new MCCV value, based on updated parameters, in response to determining the rollover timer has reached the predetermined time value.

2. The method of claim 1, wherein initializing the MCCV generator comprises:
synchronizing, on a periodic basis, at least one parameter of the parameters that are shared with a credit card verifier, wherein the parameters include user credentials and a time value.

3. The method of claim 2, wherein generating the MCCV value comprises:
calculating the MCCV value with an algorithm that is shared with the credit card verifier.

4. The method of claim 1, wherein providing the generated MCCV value comprises:
displaying the MCCV value in a manner that conveys the amount of time remaining until the rollover timer reaches the predetermined time value.

5. The method of claim 1, wherein providing the generated MCCV value comprises:
sending the MCCV value to at least one of a credit card terminal or a point of sale terminal, wherein sending includes one of displaying a quick response (QR) code or transmitting a message over a wireless channel.

6. The method of claim 1, further comprising:
receiving a deactivation signal from the credit card verifier upon notification that the mobile device is lost or stolen; and
preventing the mobile device from generating MCCV values to verify credit card transactions.

7. The method of claim 6, further comprising:
generating a code which appears to be a valid MCCV value, but instead indicates that the mobile device is being used in an unauthorized manner.

8. The method of claim 1, wherein the MCCV values are generated in an application hosted on the mobile device, and further comprising:
invoking the application upon entering at least one of a personal identification number (PIN) or a biometric signature associated with the user.

9. A method, comprising:
receiving a first transaction verification code from a mobile device, wherein the first transaction verification code is based on a transaction identifier, and further wherein the transaction identifier is provided to the mobile device by a credit card terminal;
generating a second transaction verification code, wherein the second transaction verification code is based on the transaction identifier;
determining if the first transaction verification code matches the second transaction verification code; and
generating a message approving the transaction in response to determining that the first transaction verification code matches the second transaction verification code.

10. The method of claim 9, further comprising
generating a transaction identifier;
sending the transaction identifier to a credit card terminal; and
sending the message approving the transaction to the credit card terminal.

11. The method of claim 9, further comprising:
receiving a transaction identifier from a credit card terminal; and
generating the second transaction verification code based on the received transaction identifier.

12. A device, comprising:
a memory to store instructions; and
a processor, coupled to the memory, configured to execute the instructions stored in memory to:
initialize a mobile credit card verification (MCCV) generator using parameters that are shared with a credit card verifier,
initialize a rollover timer, wherein the rollover timer is synchronized with the credit card verifier,
generate, at a mobile device, an MCCV value based on the parameters,
provide the generated MCCV value to verify a credit card transaction,
determine if the rollover timer has reached a predetermined time value, and
generate a new MCCV value, based on updated parameters, in response to determining the rollover timer has reached the predetermined time value.

13. The device of claim 12, wherein the instructions for initializing the MCCV generator comprises instructions further causing the processor to:
synchronize, on a periodic basis, at least one parameter of the parameters that are shared with a credit card verifier, wherein the parameters include user credentials and a time value.

14. The device of claim 13, wherein the instructions for generating the MCCV value comprises instructions further causing the processor to:
calculate the MCCV value with an algorithm that is shared with the credit card verifier.

15. The device of claim 12, wherein the instructions for providing the generated MCCV value comprises instructions further causing the processor to:
display the MCCV value in a manner that conveys the amount of time remaining until the rollover timer reaches the predetermined time value.

16. The device of claim 12, wherein the instructions for providing the generated MCCV value comprises instructions further causing the processor to:
send the MCCV value to at least one of a credit card terminal or a point of sale terminal, wherein sending includes one of displaying a quick response (QR) code or transmitting a message over a wireless channel.

17. The device of claim 12, further comprising instructions causing the processor to:
receive a deactivation signal from the credit card verifier upon notification that the mobile device is lost or stolen; and
prevent the mobile device from generating MCCV values to verify credit card transactions.

18. The device of claim 17, further comprising instructions causing the processor to:
generate a code which appears to be a valid MCCV value, but instead indicates that the mobile device is being used in an unauthorized manner.

19. The device of claim 12, wherein the MCCV values are generated in an application hosted on the mobile device, and further comprising instructions to:
invoke the application upon entering at least one of a personal identification number (PIN) or a biometric signature associated with the user.

20. A device, comprising:
a memory to store instructions; and
a processor, coupled to the memory, configured to execute the instructions stored in memory to:
receive a first transaction verification code from a mobile device, wherein the first transaction verification code is based on a transaction identifier, and further wherein the transaction identifier is provided to the mobile device by a credit card terminal,
generate a second transaction verification code, wherein the second transaction verification code is based on the transaction identifier,
determine if the first transaction verification code matches the second transaction verification code, and
generate a message approving the transaction in response to determining that the first transaction verification code matches the second transaction verification code.

21. The device of claim 20, comprising instructions further causing the processor to:
generate a transaction identifier;
send the transaction identifier to a credit card terminal; and
send the message approving the transaction to the credit card terminal.

22. The device of claim 20, further comprising:
receiving a transaction identifier from a credit card terminal; and
generating the second transaction verification code based on the received transaction identifier.

23. A non-transitory computer-readable medium comprising instructions, which, when executed by a processor, cause the processor to:
initialize a mobile credit card verification (MCCV) generator using parameters that are shared with a credit card verifier;
initialize a rollover timer, wherein the rollover timer is synchronized with the credit card verifier;
generate, at a mobile device, an MCCV value based on the parameters;
provide the generated MCCV value to verify a credit card transaction;
determine if the rollover timer has reached a predetermined time value; and
generate a new MCCV value, based on updated parameters, in response to determining the rollover timer has reached the predetermined time value.
